(19) United States
(12) Patent Application Publication
(10) Pub. No.: US 2014/0179266 A1
(43) Pub. Date: Jun. 26, 2014

(54) SHARED DATA MONITOR

(71) Applicant: VERIZON PATENT AND LICENSING INC., Basking Ridge, NJ (US)

(72) Inventors: Paul Schultz, Colorado Springs, CO (US); Mark J. Hahn, Stow, MA (US); Robert A. Sartini, Colorado Springs, CO (US); Jeffrey H. Swinton, Mendham, NJ (US)

(73) Assignee: VERIZON PATENT AND LICENSING INC., Basking Ridge, NJ (US)

(21) Appl. No.: 13/723,930

(22) Filed: Dec. 21, 2012

(51) Int. Cl. H04W 4/26; H04W 4/24

(52) U.S. Cl. CPC H04W 4/26; H04W 4/24
USPC 455/406; 455/405

(57) ABSTRACT

A method includes identifying a data volume allocation associated with a user account from a shared data volume allocation, identifying previous data consumption corresponding to the data volume allocation by the user account, and identifying a current data usage rate associated with the user account. The method also includes identifying a data usage threshold associated with the user account. A projected data usage is determined based on the current data usage rate and the previous data consumption. The method includes determining whether the projected data usage exceeds the data usage threshold, and, if the projected data usage exceeds the data usage threshold, sending a notification indicating that the data usage is projected to exceed the data usage threshold to at least one account associated with the shared data plan. The method further includes performing an action to limit data consumption below the data usage threshold.

### BACKGROUND

In cloud networks, content servers are often located in open networks outside of customer premises networks. Content may be downloaded from the cloud networks to users' devices. The content may include movies, music, software, etc. Content servers may receive content requests from user devices and route the requested content to the user devices, for example, via wireless networks. Additionally, communications services including voice, video and messaging also consume data resources.

### BRIEF DESCRIPTION OF THE DRAWINGS

FIG. 1 is an exemplary network environment in which systems and/or methods described herein may be implemented;

FIG. 2 is a diagram of a high level view of a shared data monitor system according to an implementation described herein;

FIG. 3 illustrates an exemplary configuration of one or more of the components of FIG. 1;

FIG. 4 is a block diagram of a shared data monitor system;

FIG. 5 is a block diagram of the data analyzer of FIG. 4;

FIG. 6 is a block diagram of the service management device of FIG. 4;

FIG. 7 is a diagram of a shared data pool relationship;

FIG. 8 is an exemplary shared data account table; and

FIG. 9 is a flow chart of an exemplary process for monitoring and controlling shared data according to an implementation described herein.

### DETAILED DESCRIPTION OF PREFERRED EMBODIMENTS

The following detailed description refers to the accompanying drawings. The same reference numbers in different drawings may identify the same or similar elements. Also, the following detailed description is exemplary and explanatory only and is not restrictive of the invention, as claimed.

Systems and/or methods described herein may provide a mechanism for monitoring, notifying and controlling usage of a shared data plan. A shared data plan may include a fixed pool of data usage that may be accessed by multiple users. Each user may be allocated a portion of the shared pool of data usage. The system may monitor data usage and implement predetermined actions based on data thresholds that may apply to the users. The system provides predictability for administrators of shared data plans and protects the users from “bill shock” (i.e., surprise from accrued charges) by informing the users about current data consumption that approaches predetermined thresholds. The system may provide data status indicators for each user of the shared data plan. Additionally, the system may invoke actions, automatically or by user command, to limit the data usage of one or more devices that are part of the shared data usage pool. While exemplary embodiments are described using primarily wireless network data usage scenarios, shared data plans for wired network data usage is also possible.

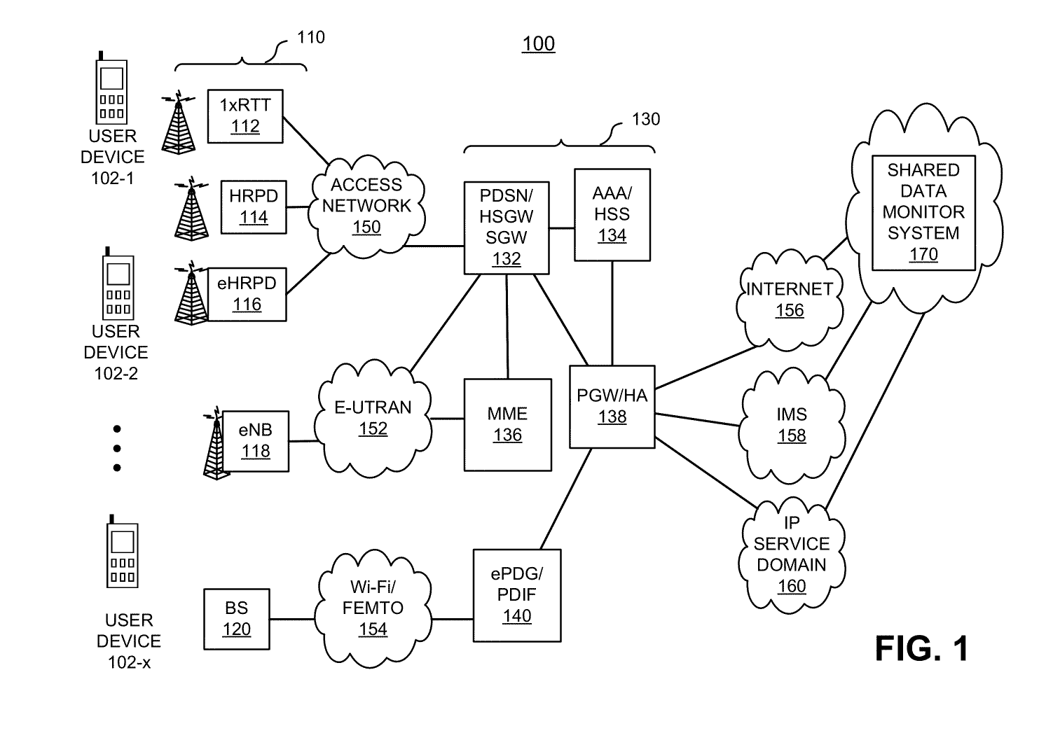

FIG. 1 is a diagram of an exemplary network 100. As illustrated, network 100 includes a number of user devices 102-1 through 102-x (collectively referred to as user devices 102 or individually as user device 102), base stations 110, and routing devices 130. Base stations 110 may include a 1x radio transmission technology (RTT) device 112, a high rate packet data (HRPD) device 114, an enhanced HRPD (eHRPD) device 116, an enhanced node base station (referred to as an eNodeB) (eNB) 118, and a Wi-Fi/Femto-cell (FEMTO) network device 120. Gateway devices may include a packet data serving node (PDSN)/an HRPD serving gateway (HSGW)/SGW 132, an authentication, authorization, and accounting (AAA) server/home subscriber server (HSS) 134, a mobility management entity (MME) 136, a packet data network (PDN) gateway (PGW)/home agent (HA) node 138 and an evolved packet data gateway (ePDG)/packet data interworking function (PDIF) device 140. Network 100 may include an access network (AN) 150, an evolved universal terrestrial radio access network (E-UTRAN) 152, a Wi-Fi/Femto-cell/untrusted network 154, the Internet 156, an Internet Protocol Multimedia subsystem (IMS) network 158, and a customer IP service domain 160. Network 100 may also include a shared data monitor system 170. Devices/networks of network 100 may interconnect via wired and/or wireless connections.

Three user devices 102, a 1xRTT device 112, HRPD device 114, eHRPD device 116, eNodeB 118, Wi-Fi/FEMTO network device 120, PDSN/HSGW/SGW 132, AAA/HSS server 134, MME 136, PGW/HA 138, and ePDG/PDIF 140 are illustrated in FIG. 1 for simplicity. In practice, there may be more or fewer devices or components.

User device 102 may include a radiotelephone, a personal communications system (PCS) terminal (e.g., that may combine a cellular radiotelephone with data processing and data communications capabilities), a wireless telephone, a cellular telephone, a smart phone, a personal digital assistant (PDA) (e.g., that can include a radiotelephone, a pager, Internet/intranet access, etc.), a laptop computer, a personal computer, a tablet computer, a sensor, or other types of computation or communication devices. In an exemplary implementation, user devices 102 may include any device that is capable of communicating over AN 150, E-UTRAN 152, and/or Wi-Fi/Femto-cell/untrusted network 154. User device 102 may operate according to one or more versions of the long term evolution (LTE or fourth generation (4G) LTE) communication standard. User device 102 may be associated with a user account and consume data including voice, video, web access, email, voice over Internet Protocol (VoIP), etc.

Base stations 110 may send wireless signals to user devices 102 and may receive wireless signals from user devices 102 in network 100. Base stations 110, including 1xRTT device 112, HRPD device 114, eHRPD device 116, eNodeB 118, Wi-Fi/FEMTO network device 120, may operate according to corresponding standards on different networks.

1xRTT device 112, HRPD device 114, and eHRPD device 116 include network devices that operate according to one or more versions of the RTT standard, the HRPD standard and/or the eHRPD standard. 1xRTT device 112. HRPD device 114, and eHRPD device 116 may be configured to respond to user device 102 requests, and forward information regarding user devices 102 to PDSN/HSGW/SGW 132.

eNBs 118 includes network devices that operate according to one or more versions of the LTE communication standard. For example, eNBs 118 may be configured to respond to user device requests, forward information regarding user devices 102 to MME 136 and/or PDSN/HSGW/SGW 132, set up tunneling sessions with other devices (e.g., PDSN/HSGW SGW 132), etc. eNBs 118 are base stations in network 100 and may include control plane connections to other network elements.

Wi-Fi/FEMTO network 156 includes network devices that operate according to one or more versions of the Wi-Fi/FEMTO standard. Wi-Fi/FEMTO network 156 may be configured to respond to user device requests, forward information regarding user devices 102 to ePDG/PDIF 140.

Routing devices 130 may route and forward user data packets associated with different user devices 102 and user accounts. As indicated above, routing devices 130 may include PDSN/HSGW/SGW 132, AAA/HSS server 134, MME 136, PGW/HA 138, and ePDG/PDIF 140.

PDSN/HSGW/SGW 132 may route and forward user data packets, act as a radio mobility anchor for a user plane during inter-eNB handovers, and also act as a radio anchor for mobility between LTE and other Third generation partnership project (3GPP) technologies (referred to as “inter-3GPP mobility”). As shown, PDSN/HSGW/SGW 132 is connected to eNBs 118 to provide a radio layer mobility control plane. In addition, PDSN/HSGW/SGW 132 manages and stores contexts associated with user device 102 (e.g., parameters of an IP bearer service, network internal routing information, etc.).

AAA/HSS 134 is configured to include a master user database that supports devices that handle communication sessions, such as proxy devices, session border controllers, etc. AAA/HSS 134 may contain subscription-related information (e.g., subscriber profiles), may perform authentication and authorization of a user based on requests received from MME 136, and may provide information about a subscriber's location and IP information.

MME 136 is responsible for idle mode tracking and paging procedures (e.g., including retransmissions) for user device 102. For example, MME 136 maintains information regarding a current state (e.g., powered on, location, etc.) of user device 102. MME 136 is also involved in the bearer activation/deactivation process (e.g., for user device 102) and operates to choose a particular PDSN/HSGW/SGW 132 for user device 102 at an initial attach time and at a time of intra-LTE handover. In addition, MME 136 authenticates user device 102 (e.g., via interaction with AAA/HSS 134). Non-access stratum (NAS) signaling terminates at MME 136 and MME 136 generates and allocates temporary identities to user equipment (e.g., user device 102).

PGW/HA 138 includes one or more data transfer devices (or network devices), such as a gateway, a router, a switch, a firewall, a network interface controller (NIC), a hub, a bridge, a proxy server, an optical add/drop multiplexer OADM, or some other type of device that processes and/or transfers data. PGW/HA 138 provides connectivity of user device 102 to external packet data networks by being a traffic exit/entry point for user device 102. PGW/HA 138 may perform policy enforcement, packet filtering for each user, charging support, lawful intercept, and packet screening. PGW/HA 138 may also act as an anchor for mobility between 3GPP and non-3GPP technologies.

ePDG/PDIF 140 may allow access to the IMS networks via Wi-Fi access points. ePDG/PDIF 140 may rely upon and enhance security from gateway/routing devices 130 to protect resources and packet data services from unauthorized access.

AN 150 includes a communications network that connects subscribers (e.g., user device 102) to a service provider. In one example, AN 150 may include a Wi-Fi network or other access networks (e.g., in addition to E-UTRAN 112). AN 150 may include a core network architecture of the Third generation partnership project (3GPP) LTE wireless communication standard. AN 150 may provide data services (e.g., via packets or any other Internet protocol (IP) datagrams).

E-UTRAN 152 includes a radio access network capable of supporting high data rates, packet optimization (e.g., shortened path, reduced network time, etc.), large capacity and coverage, etc. E-UTRAN 152 may include a number of eNBs 118.

Wi-Fi/FEMTO network 154 may include a wireless network or a femto-cell network that may provide wireless access to data services on network 100. The Internet 156 may include a global system of interconnected networks that use a standard Internet Protocol suite to connect devices. IMS 158 may include a network that delivers IP multimedia services to devices. IP service domain 160 may include an IP service domain defined by domain name system (DNS).

Shared data monitor system 170 may connect to PGW/HA 138 via the Internet 156, an IMS network 158 and/or IP service domain 160. In implementations described herein, systems and methods described with respect to shared data monitor system 170 may provide a mechanism for monitoring, notifying and controlling usage of data (i.e., a data usage volume associated with a particular user or set of users) based on a shared data plan. The shared data plan may include a fixed pool of data usage that may be consumed by multiple users. Each user may be allocated a portion of the shared pool of data usage.

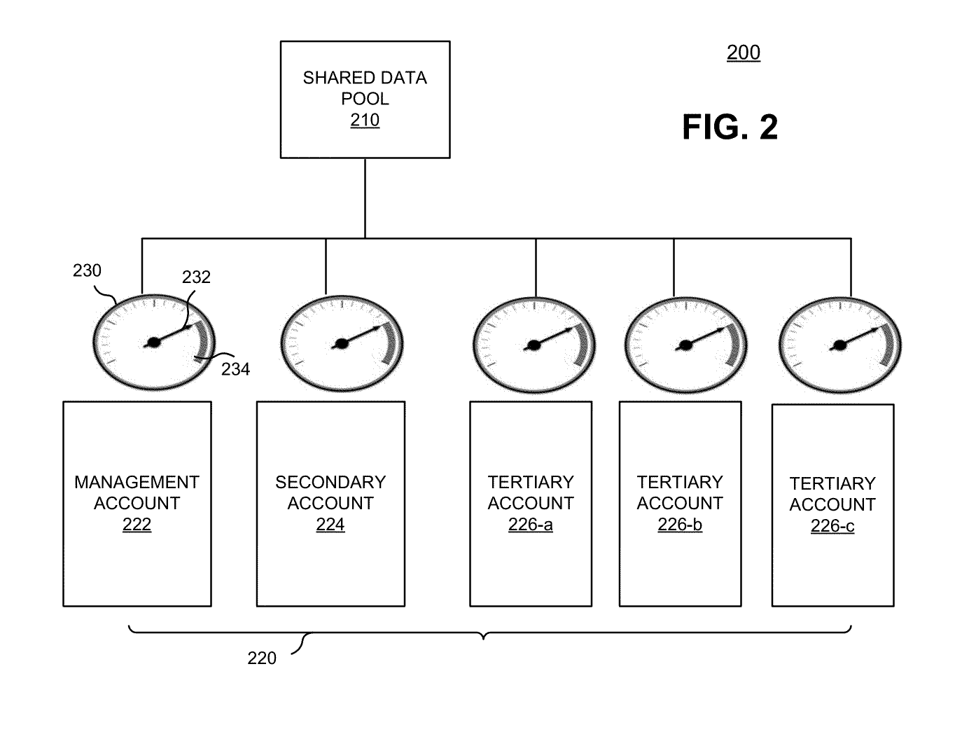

FIG. 2 is a conceptual diagram of a data share plan 200. As shown in FIG. 2, a shared data pool 210 may be shared across a group of user accounts 220. The group of user accounts 220 may include a management account 222, a secondary account 224, and tertiary accounts 226 (shown as tertiary accounts 226-a to 226-c). Each account may have an associated data status indicator 230.

Shared data pool 210 may include a periodic (e.g., monthly, weekly, per billing period, etc.) allotment of data (i.e., an amount of data transmission in network 100) that may be accessed in association with user accounts 220. The data usage may be provided by a service provider in association with a particular network(s) (e.g., cellular networks, cable networks, fiber networks, satellite networks, WiFi networks, etc.). In one example, the shared data pool 210 may include a fixed “bucket” of data with a threshold above which data charges are administered as overages (e.g., data above the shared data pool allotment may be charged at a higher rate on a per data unit basis). In another example, the shared data pool 210 may include a pool of data with an adjustable threshold. In this instance, the allotment of data may be increased by purchasing the additional allotment of data (at a lower rate than the overages). A new threshold(s) may be established based on the new allotment of data.

The user data accounts 220 may include different privileges and allotments of data. For example, management account 222 may have privileges to set thresholds for the shared data among different user accounts (e.g., an administrator may assign different thresholds to user accounts 220 based on a business function or expected usage level of the user associated with the account). Shared data monitor system 170 may support heterogeneous devices (associated with user accounts 220) that consume data (e.g., sensors, wearable computing, smartphone, tablet, PC, television (TV)).

Data status indicator 230 may indicate a current level of consumption for each user data account 220. As shown in FIG. 2, data status indicator 230 is a visual representation of an amount of data that is being consumed by a user. Data status indicator is shown as similar to a speedometer in which a dial 232 represents a current rate of consumption and the area 234 represents a rate of consumption at which the data threshold is likely to be exceeded.

Shared data monitor system 170 may provide a capability for the administrators or users to set predefined thresholds at which predetermined actions are triggered. As described below, the predetermined actions may include notification to the users and/or modification of data service, including change of network (e.g., reestablish network on lower data rate/speed), smaller file sizes, web browsing without downloaded images, etc.). An overall data rate may also be changed and/or content allowance may be adjusted (e.g., no streaming video) to establish a lower data usage. Shared data monitor system 170 may send a notification (e.g., audio, visual and/or haptic indications) to a user when data consumption approaches or exceeds a predetermined threshold.

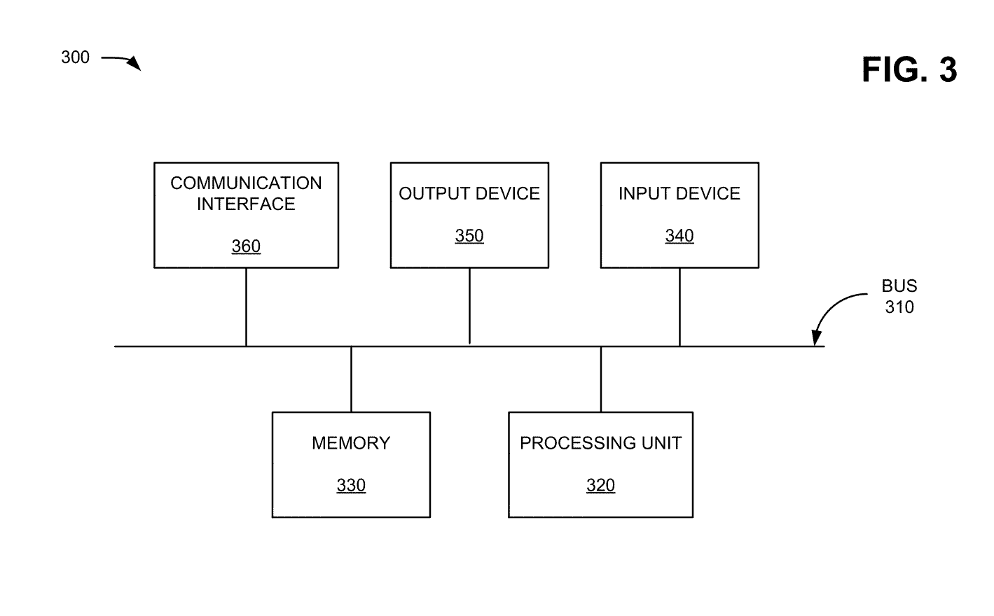

FIG. 3 is a diagram of example components of a device 300. Each of user device 102 and/or one or more of 1xRTT device 112, HRPD device 114, eHRPD device 116, eNodeB 118, Wi-Fi/FEMTO network device 120, PDSN/HSGW SGW 132, AAA/HSS server 134, MME 136, PGW/HA 138, ePDG/PDIF 140 or shared data monitor system 170 as described in FIGS. 1-2 above may include one or more devices 300. As shown in FIG. 3, device 300 may include a bus 310, a processing unit 320, a memory 330, an input device 340, an output device 350, and a communication interface 360.

Bus 310 may permit communication among the components of device 300. Processing unit 320 may include one or more processors or microprocessors that interpret and execute instructions. In other implementations, processing unit 320 may be implemented as or include one or more application specific integrated circuits (ASICs), field programmable gate arrays (FPGAs), or the like.

Memory 330 may include a random access memory (RAM) or another type of dynamic storage device that stores information and instructions for execution by processing unit 320, a read only memory (ROM) or another type of static storage device that stores static information and instructions for the processing unit 320, and/or some other type of magnetic or optical recording medium and its corresponding drive for storing information and/or instructions.

Input device 340 may include a device that permits an operator to input information to device 300, such as a keyboard, a keypad, a mouse, a pen, a microphone, one or more biometric mechanisms, and the like. Output device 350 may include a device that outputs information to the operator, such as a display, a speaker, haptics, etc.

Communication interface 360 may include a transceiver that enables device 300 to communicate with other devices and/or systems. For example, communication interface 360 may include mechanisms for communicating with other devices, such as other devices of network 100.

As described herein, device 300 may perform certain operations in response to processing unit 320 executing machine-readable instructions contained in a computer-readable medium, such as memory 330. A computer-readable medium may be defined as a non-transitory memory device. A memory device may include space within a single physical memory device or spread across multiple physical memory devices. The machine-readable instructions may be read into memory 330 from another computer-readable medium or from another device via communication interface 360. The machine-readable instructions contained in memory 330 may cause processing unit 320 to perform processes described herein. Alternatively, hardwired circuitry may be used in place of or in combination with machine-readable instructions to implement processes described herein. Thus, implementations described herein are not limited to any specific combination of hardware circuitry and software.

Although FIG. 3 shows example components of device 300, in other implementations, device 300 may include fewer components, different components, differently arranged components, or additional components than depicted in FIG. 3. As an example, in some implementations, output device 350 may not include a display. In these situations, device 300 may be a “headless” device that does not include an output device. Some devices may be machine-to-machine devices (e.g., sensors). Alternatively, or additionally, one or more components of device 300 may perform one or more other tasks described as being performed by one or more other components of device 300.

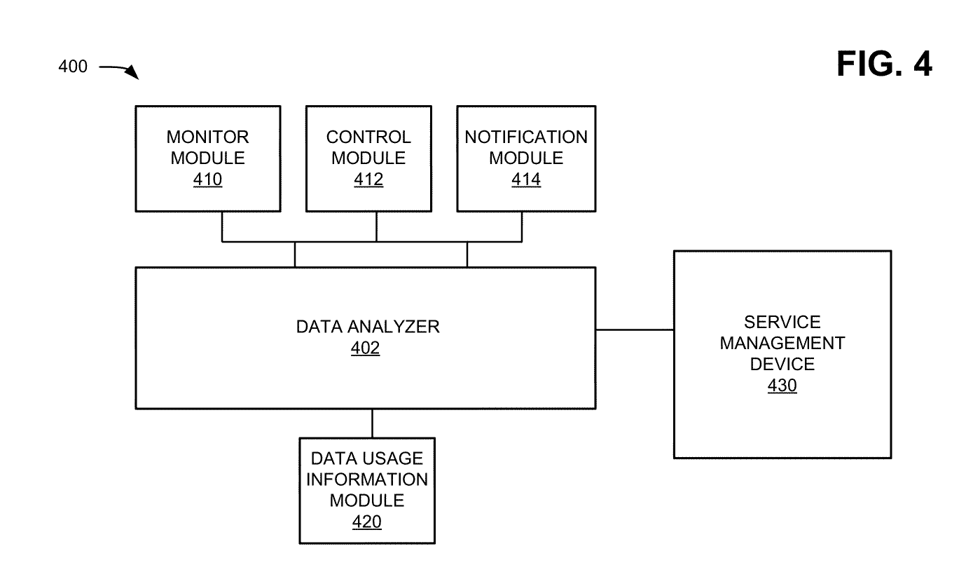

FIG. 4 is an exemplary functional block diagram of a shared data monitor system 170 according to an exemplary implementation. Shared data monitor system 170 may include a data analyzer 402, a monitor module 410, a control module 412, a notification module 414, an data usage information module 420 and a service management module 430. The logical blocks illustrated in FIG. 4 may be implemented in machine-readable instructions, hardware, or a combination of hardware and machine-readable instructions. For example, in one implementation, all or some of the logical blocks illustrated in FIG. 4 may be implemented by processing unit 320 (FIG. 3) executing machine-readable instructions stored in, for example, memory 330. Shared data monitor system 170 may be implemented in a single device or multiple devices across a network, such as network 100.

Data analyzer 402 may receive and analyze information related to or associated with data consumption of shared data plan users. Information may include networks, devices, content types, communications sessions, applications, etc., associated with the data consumption for a user account. Data analyzer 402 may perform data analysis to implement functions in conjunction with monitor module 410, control module 412, notification module 414, and/or data usage information module 420. Data analyzer 402 may access information from service management module 430 to analyze the data consumption with respect to particular users and shared data plans. Data analyzer 402 may support heterogeneous devices that consume data (e.g., sensors, wearable computing, smartphone, tablet, personal computer (PC), TV, etc.). Data analyzer 402 may include a capability of monitoring data usage, controlling data usage and generating notifications on a per user and/or aggregate user (e.g., shared data plan users, multiple devices/user, etc.) basis.

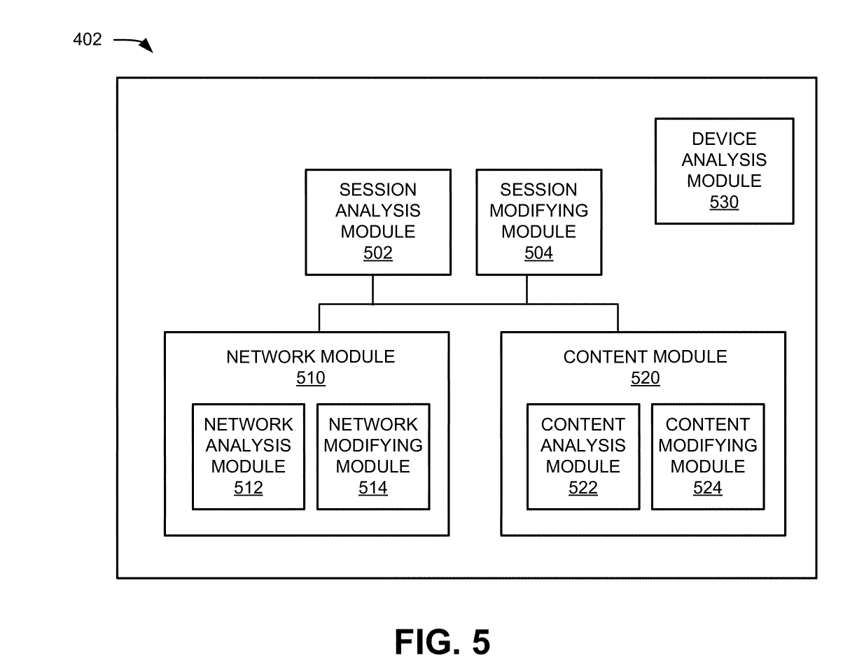

Monitor module 410 may perform data monitoring functions in network 100 with regard to data usage accounts and a shared data pool 210. Monitor module 410 may compare data usage to predetermined data usage thresholds to identify data usage events that may require data usage control and/or notification processing. The data usage threshold may be a level of data consumption that may lead to the user exceeding their shared data allocation. Monitor module 410 may utilize data analyzer 402 to analyze information related to data consumption by a particular user based on network details, communications session details, content details and/or device details (e.g., applications running on device, device context), for example as described with respect to FIG. 5.

Control module 412 may control (e.g., turn off, modify) sessions that are consuming shared data. Control module 412 may perform control function based on preferences on a per account basis to reduce a rate of data consumption associated with a user that is approaching or has exceeded a predetermined threshold. Emergency sessions (e.g., E-911) may be identified such that they are always allowed to proceed regardless of any data usage thresholds. Control module 412 may implement user data consumption rate reduction based on a hierarchy of responses in order of increasing severity for handling or addressing data usage. A first level response may be least severe, such as an initial notification that the user is approaching the predetermined threshold. Higher level responses may reduce or curtail a user data consumption rate. For example, control module 412 may reduce data rates (e.g., slower web page loading, audio instead of video calls, codec negotiation to lower rate (e.g., G729 vs. G711), etc.), or reduce allowed content types (e.g., smaller/no web page images, lower frame rate video, lower quality video/audio, etc.). An account administrator may select a mix of responses for the control module 412 to implement user data consumption rate reduction on a per user basis or generally for all users under the shared data plan. In some instances the administrator may manually select a response to implement user data rate reduction.

According to one implementation, control module 412 may reallocate or rebalance data in order to bring an account back in to compliance with a data plan. The user account may be in compliance when projected data usage is within the allotted data amount for the user account. Control module 412 may include a capability to identify “excess” data associated with one user that is significantly under a data consumption allotment and potentially transfer a portion of the unused allotment to another user or the shared data plan. For example, if the user is consuming more data than initially allocated, control module 412 may transfer unused data allocation to the user to bring the user account into compliance.

Notification module 414 may generate notifications to (e.g., user devices 102 associated with) users and/or account administrators when data usage events occur. For example, notification module 414 may provide notification to an account administrator and user when a user's data usage exceeds predefined thresholds. Additionally, notification module 414 may provide a notification that includes offers for additional shared data capacity (e.g., at a reduced rate with respect to overage charges). Data usage notifications may include audio, visual and haptic feedback as part of the user experience. Notification module 414 may inform users ahead of time before a particular data threshold is crossed. For example, notification module 414 may provide a notification that someone is over running data allocation to an administrator and allow the administrator to manually take action.

Data usage information module 420 may interface with a data consumption related entity (e.g., devices associated with a data provider or data consumer) and expose data usage information to the data consumption related entity based on privacy, permissions and preferences for the account user and/or account administrator that data usage information module 420 accesses, for example, from service management module 430. Data consumption related entities (e.g., third parties or the service provider) may determine data service offerings that supplement, supersede or adapt to the current shared data usage plan based on the data usage information. For example, a data provider may make decisions on service delivery (e.g., delivery of lower bandwidth services when a user is data usage constrained) and/or to offer different services to the user (e.g., free-to-end-user video or audio streaming in exchange for the user receiving embedded advertising). In another example, a data consumer (e.g., the browser used by a shared data user browsing Internet content) may utilize the user's shared data information to deliver lower data consumption services to the user. In this manner, data consumers such as web browsers may become user “data constraint” aware. In a further example, the data provider may provide a modified plan that includes an “opt in” and additional data may be provided that doesn't count against the shared data plan.

Authorized third party applications may receive shared data plan information from the service provider and provide or consume data based on this shared data plan information (e.g., the third party application may be a video streaming service that only provides service when the user is below data usage thresholds; additionally or alternatively, the application may provide higher data rate services at off-peak network utilization timeframes). In one example, data providers may provide timely “data upsell” notifications and offers to users that are approaching usage thresholds. Data upsell notifications may inform the user of opportunities to purchase additional data allocations that may prevent the user from exceeding a current allocation. Data usage information module 420 may allow the user to reduce cost or structure data purchases by pre-purchase of data usage capacity. Data usage information module 420 may provide the data usage information to benefit both the user (lower rate for data when they know they will exceed their allowance) and the service provider (additional data revenue). In another example, data usage information module 420 may provide data consumption information to a third party service provider. The third party service provider may offer to provide data associated with a third party data service in which the offer is based on the user accepting the third party data service (e.g., free data to the user as part of a video streaming service). The user may receive the offer to provide data associated with the third party data service from the third party service provider. If the user accepts the offer (and starts the third party data service), data usage information module 420 (and other modules associated with the service provider, such as data analyzer 402) may exclude data consumed in association with the third party service from the data usage counted against the data usage threshold.

The service provider may provide a “dynamic on demand” rate notification based on the current real-time demand for data in network 100. In instances in which data consumption capacity usage is low (i.e., network 100 capacity is under-utilized), the service provider may offer a lower rate to provide an incentive for users. Data usage information module 420 may provide a notification before a video stream/download occurs, identify to the user what the current data rate is, and allow the user to choose whether to allocate the data usage against their shared data plan or to accept a modification or upsell based on the data usage.

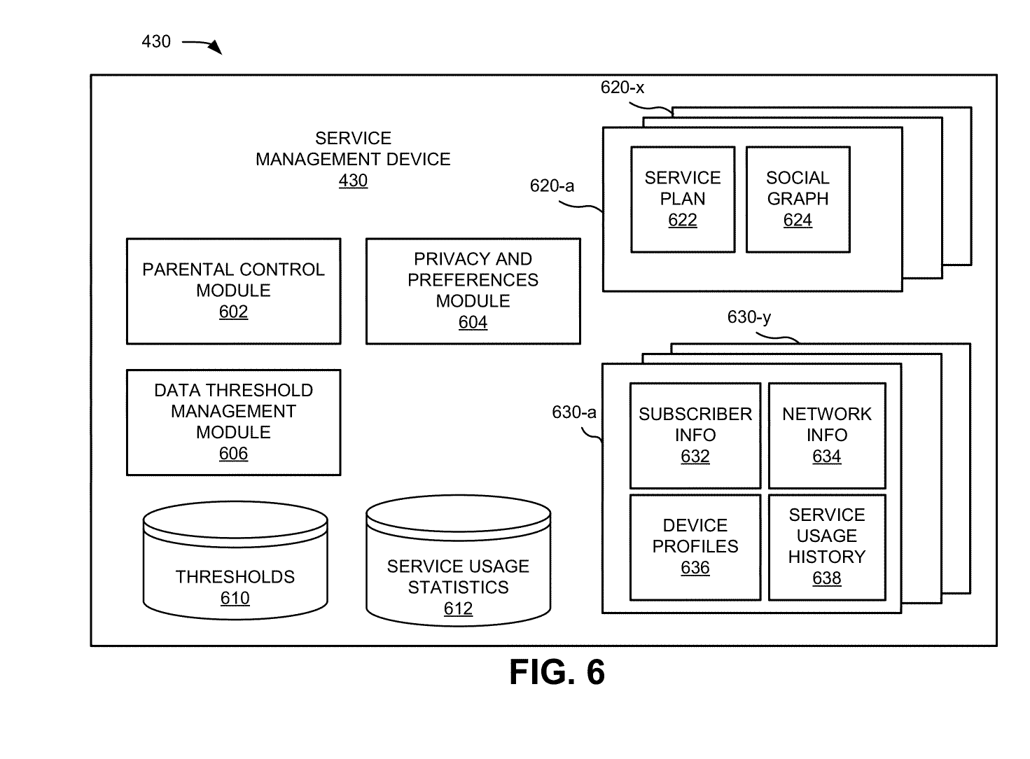

Service management module 430 may provide service information on an account, shared data plan, or user as described below with respect to FIG. 6. Service management module 430 may provide information based on a relationship of the requesting individual/entity with regard to a family plan, a business share plan, etc. For example, service management module 430 may provide different levels of information to an administrator of the shared data plan, a user under the shared data plan, or a third party data provider.

FIG. 5 is an exemplary functional block diagram of data analyzer 402. Data analyzer 402 may include a session analysis module 502, a session modifying module 504, a network module 510, a content module 520 and a device analysis module 530. Depending on the implementation, data analyzer 402 may include additional, fewer, different, or a different arrangement of components than those illustrated in FIG. 5.

Session analysis module 502 may analyze user network sessions to determine a current level of data usage associated with a user and/or a shared data usage plan. Session analysis module 502 may analyze the user network sessions in conjunction with network module 510 (to determine data usage with regard to network resources) and/or content module 520 (to determine data usage with respect to different types of content).

Session modifying module 504 may modify user network sessions. For example, session modifying module 504 may reduce the rate of data usage via modification of network capabilities (e.g., in conjunction with network module 510, switch networks, modify network data rate, etc.) and/or modification of content delivered to the user (e.g., in conjunction with content module 520, provide smaller image sizes, smaller video sizes, disallow video content, etc.). Session modifying module 504 may suggest (e.g., in conjunction with notification module 414), or force use of different networks (e.g., Wi-Fi) when data use crosses pre-defined thresholds. For example, an account administrator may provide a rule that forces an over-consuming shared data plan user to Wi-Fi-only data usage for the remainder of a billing cycle. Session modifying module 504 may learn about a user or administrator's preferences and implement modification of user network sessions based on previous input received from the user and/or historical usage information from month to month.

Network module 510 may implement analysis and modifying of network connections with respect to user network sessions for shared data users. Network module 510 may include a network analysis module 512 and a network modifying module 514. Network analysis module 512 may analyze the effect of different networks on data usage rates associated with the shared data usage plan. Network modifying module 514 may modify user network connections to reduce or eliminate data consumption. Network modifying module 514 may modify the user network session to lower data usage. For example, network modifying module 514 may “downgrade” a video session to an audio session, re-negotiate an audio codec from International Telecommunication Union (ITU) standard G729 audio data compression to G711 audio data compression, or re-establish a session with a Wi-Fi network from a macro-cellular (e.g., 4G LTE) network.

Content module 520 may implement analysis and modifying of content types included with respect to user network sessions for shared data users. Content module 520 may include a content analysis module 522 and a content modifying module 524. Content analysis module 522 may analyze a user network session to determine the effect on data usage rates if particular types of content are included or excluded from the user network session. Content modifying module 524 may modify user network sessions to reduce or eliminate data content consumption. For example, content module 520 may “downgrade” a video session to a lower quality, serve smaller video and image sizes from a content delivery network (CDN), etc.

Device analysis module 530 may determine data consumption from the device perspective and may inform a user about device applications to minimize data consumption. Device analysis module 530, for example, may identify applications running on the device that are consuming large amounts of data. Device analysis module 530 may notify the user based on this information and initiate session and/or content control (e.g., data consumption minimization).

FIG. 6 is a functional block diagram of a service management module 430. As shown in FIG. 6, service management device 430 includes a parental control module 602, a privacy and preferences module 604, a data threshold management module 606, thresholds 610, service usage statistics 612, shared data plan accounts 620 (shown as shared data plan accounts 620-a to 620-x) and subscriber accounts 630 (shown as subscriber accounts 630-a to 630-y). Depending on the implementation, service management module may include additional, fewer, different, or a different arrangement of components than those illustrated in FIG. 6.

Service management module 430 may provide service information on an account, and implement thresholds, permissions, privacy policies, preferences, and parental controls in conjunction with data analyzer 402 described with respect to FIG. 5 herein above.

Parental control module 602 may determine parental controls that are to be applied to designated child user accounts associated with the shared data plan. Parental controls may be tied to data usage caps. Parental control module 602 may allow authorized users (e.g., a parent) to minimize data usage at selected times or for selected purposes (e.g., a parent may disallow data consumption while a student is in class, and prevent a young child from streaming video to their mobile device at all times).

Privacy and preferences module 604 may enforce privacy policies, permissions, and preferences for each user associated with the shared data plan. For example, privacy and preferences module 604 may limit access to information regarding specific content associated with data consumption by a particular user. Privacy and preferences module 604 may provide permissions for the user to access different types of data. Privacy, permissions, and preferences may be input by the account administrator.

Data threshold management module 606 may manage data thresholds 610 for the shared data plan for the group of users or on an individual user basis. The data thresholds 610 may identify levels of consumption at which users are to be notified. The data thresholds 610 may be based on a data allocation for each user, for the overall shared data plan or for a combination of the shared data plan and an allocation for a particular user (e.g., a general data allocation in addition to the user data allocation).

Data threshold management module 606 may provide information regarding data thresholds 610 to data analyzer 402. Data threshold management module 606 may determine thresholds 610 for users based on data allocations and usage patterns (e.g., derived from service usage statistics 612 and/or service usage history 638). Data threshold 610 may be an aggregate (i.e., all users may access the general shared data pool 210 until the threshold is approached/breached) or an individual data cap violation (users may breach an individual allotment). In one example, data threshold management module 606 may determine a threshold at which notification is triggered to allow the user to bring the user account back into compliance with the data plan (e.g., data threshold management module 606 may determine how close to exceeding the allocation before a notification or other actions are taken).

An account administrator may set types of data thresholds 610 with some users being allocated a higher amount of data usage. Data threshold management module 606 may identify a hierarchy of types of networks, communications sessions and content that is to be controlled to reduce data usage rates. For example, data threshold management module 606 may provide a rule to utilize a Wi-Fi network as opposed to more expensive-to-use macro-cellular network. Data threshold management module 606 may provide different rules based on content types accessed during the user network session. Data threshold management module 606 may provide exceptions based on particular domains, websites, etc., associated with the content/data (e.g., data threshold caps may not apply to identified educational or business websites).

Service usage statistics 612 may indicate current and historical patterns of data consumption with regard to each member in the shared data plan and the overall shared data plan. Service usage statistics 612 may indicate periodic data consumption for shared data plans on an a shared data plan account of an individual user account basis,

Shared data plan accounts 620 may include information regarding the shared data plans, such as a service plan 622, and a social graph 624. The service plan 622 may identify an overall data allocation, billing, subscribed services, terms of service, etc., and the social graph 624 may identify relationships between users with regard to privacy, access to information, and individual allotment of data. For example, the shared data plan may be for an extended family in which people are treated differently based on social graph. The service plan 622 may also include access to administrative functions, such as described with respect to account administration table 800 below. Different data allotments and different responses may be provided based on the social graph when users cross various data consumption thresholds.

Subscriber accounts 630 include information for each subscriber associated with the shared data plan. Subscriber accounts 630 may include subscriber information (info) 632, network information 634, device profiles 636, and service usage history 638. Subscriber information 632 may include personal information about the subscriber (e.g., age, gender, eye color, biometrics, ethnicity, etc.), geographic (address) information, etc. Network information 634 may include information regarding networks that are associated with the user or which the user may access. Device profiles 636 may identify data consumption characteristics of devices associated with the subscriber (e.g., a subscriber may use only lower data consumption voice services with a particular device or devices). Service usage history 638 may include records of past data consumption associated with the user. The record may include periodic data consumption (e.g., an hourly log of data consumption rates), types of content consumed, etc.

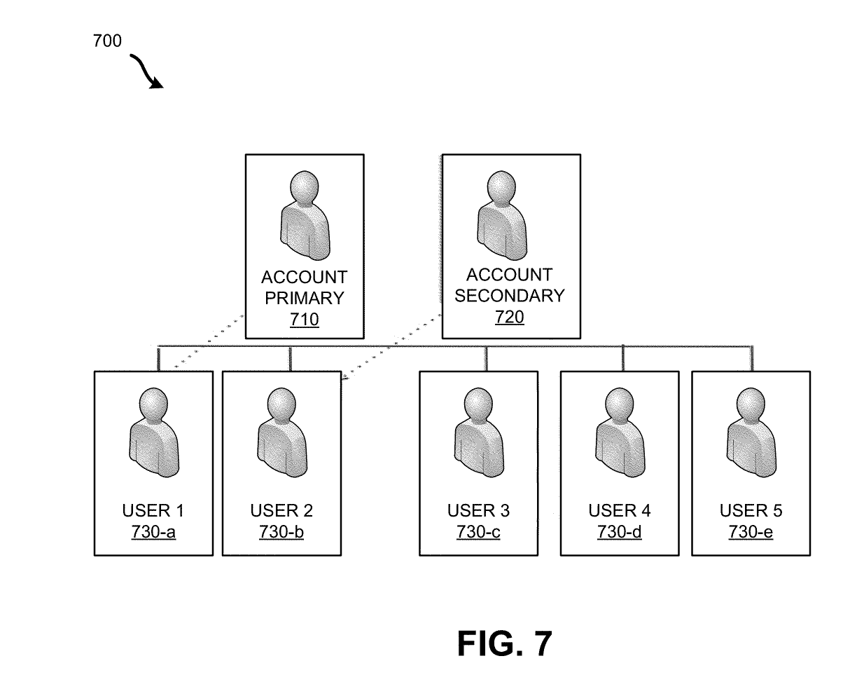

FIG. 7 shows a diagram of a shared data plan relationship 700. As shown in FIG. 7, shared data plan relationship may include an account primary 710, an account secondary 720, and users 730 (shown as user 730-a to 730-e). Depending on the implementation, shared data plan relationship 700 may include additional, fewer, different, or a different arrangement of accounts than those illustrated in FIG. 7.

Account administrator(s) may be associated with account primary 710 and may set thresholds and determine data allocations for the users 730 in the shared data plan. The account administrator may specify data usage thresholds to trigger different actions in network 100 (e.g., for data usage notifications, data usage control (e.g., data usage minimization), etc.). In one implementation, user accounts 710 may include an account that corresponds to the account primary 710. Such an account, like other accounts, may also have a threshold. In other implementations, the account primary 710 may be separate from user accounts 730 and may not receive a data allotment (e.g., an enterprise account administrator). Account administrators may be responsible for payment for the cost of data usage and may manage user consumption of the shared data pool 210 when usage thresholds have been exceeded.

User accounts (users) 730 may receive data allotments from the shared data pool 210. In some implementations, the data allotments may be shared evenly with all user accounts 730. In other implementations, designated users 730 may receive greater data allotments. For example, sales people or other users 730 that are expected to communicate as a part of their job function may be given a greater data allotment.

According to one example, a device associated with account primary 710 may receive a data usage alert. Additionally or alternatively, notifications/alerts for devices (e.g., machine-to-machine sensor) may be directed only to account administrators and not to the device itself. The account administrator may drilldown (e.g., access additional information based on information provided) to identify the cause of the data usage threshold alert. In this example, the data usage alert may be generated because user 4 is exceeding her data usage quota. The account administrator may have previously specified particular actions to be taken by shared data monitor system 170 in response to the user exceeding the predetermined threshold.

In another example, account administrator (e.g., account primary 710) may manually initiate a data usage minimization process after receiving a notification of the user exceeding or approaching the thresholds (e.g., account administrator may decide that user 4 (730-d) must use voice-only communications instead of voice and video communications for the remainder of the billing period). In other implementations, the account administrator may provide “media specific” data allocations (e.g., video, web browsing, audio communications, music download, etc.) that may be monitored, administered, and controlled separately. The account administrator may implement manual (e.g., on-demand based on a data usage Notification) or automated (e.g., based on pre-defined thresholds and actions) session and/or content modifications.

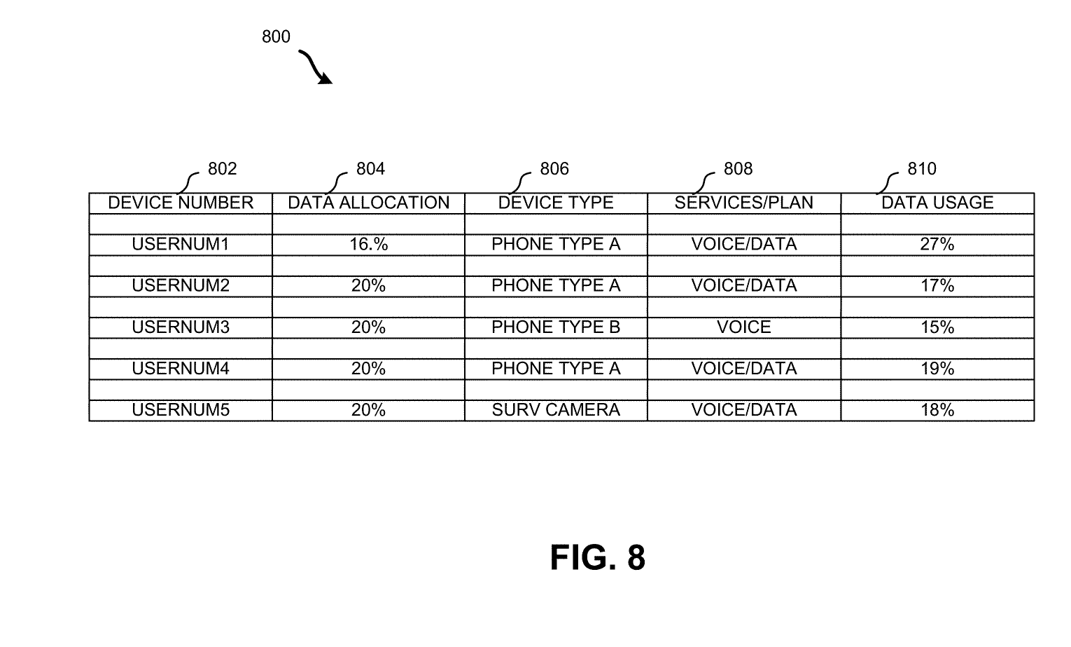

FIG. 8 shows an account administration table 800. As shown in FIG. 8, account administration table 800 includes columns for a device number 802, data allocation 804, device type 806, services/plan 808, and data usage 810 associated with user accounts. Account administration table 800 may be stored in conjunction with an account for an administrator (e.g., with service plan 622 described in FIG. 6).

Device number 802 includes a number associated with devices for a user account (shown as usernum1 to usernum5 in FIG. 8). Data allocation 804 may indicate a percentage of the total shared data pool that is allocated to the user. Device type 806 may indicate a type of user device 102 associated with each user. For example, device types 806 may include heterogeneous devices as shown in table 800, such as different phones (e.g., phone type A and phone B may have different capabilities) and surveillance (surv) cameras. Services/plan 808 may indicate services that are subscribed to for that particular user. Data usage 810 may indicate the amount of data that the user has consumed in a particular month. Data usage 810 may be associated with different applications and devices, such as video, voice, data, and machine-to-machine applications. Data usage 810 may be provided on a historical and/or a current basis. The account administrator may leverage information about previous billing cycle data usage to set thresholds.

An account administrator may access account administration table 800 to determine perspective of shared data in the shared data plan. The account administrator may choose to allocate data in different proportions across users and drill down for additional user information. The account administrator (or the system automatically) may redistribute the data allocation by reallocating data from under-consuming users in the shared plan to over-consuming users.

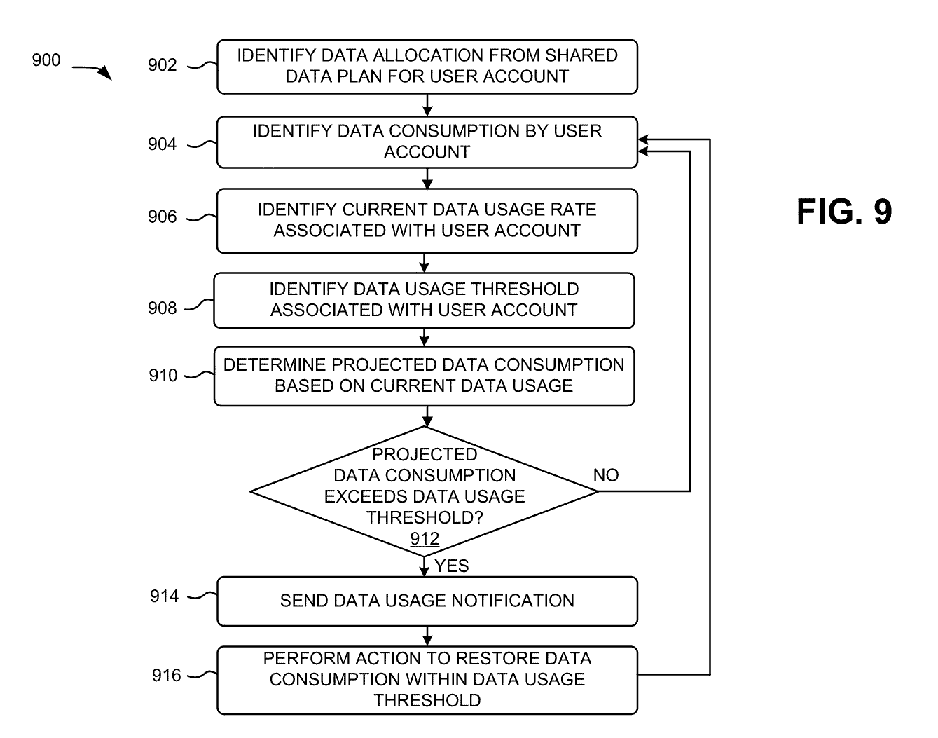

FIG. 9 is a flowchart of an exemplary process 900 for monitoring and controlling shared data usage according to implementations described herein. Process 900 is described with respect to data analyzer 402 shown in FIG. 4, for illustrative purposes. In one implementation, process 900 may be performed by data analyzer 402. In another implementation, some or all of process 900 may be performed by another device or group of devices, including or excluding data analyzer 402.

Data analyzer 402 may identify a data allocation for a user account(s) (block 902). For example, data analyzer 402 may receive a data allocation associated with the user account at a beginning of a billing cycle.

At block 904, data analyzer 402 may identify data consumption corresponding to the data allocation by the user account. For example, data analyzer 402 may determine a total of data consumed by the user within the current period. The data may be debited from the data allocation from the shared data plan.

Data analyzer 402 may identify a current data usage rate associated with the user account (block 906). For example, data analyzer 402 may determine a type of user network session that the user has currently established. Data analyzer 402 may identify a rate of data use associated with the user account.

Data analyzer 402 may identify a data usage threshold associated with the user account (block 908). For example, data analyzer 402 may identify the data usage threshold based on the data allocation for the user account. The data usage threshold may be an amount, lower than the data allocation, at which an account administrator may provide a notification to the user (e.g., at 70% of the data allocation). The data usage threshold may be determined for the entire period or on a prorated basis. For example, the data usage threshold may be a daily data usage threshold, a weekly data usage threshold or a monthly data usage threshold.

At block 910, data analyzer 402 may determine a projected data consumption based on current data usage rate. For example, data analyzer 402 may extrapolate data usage for the remainder of the current period based on information about user sessions (e.g., amount of data associated with streaming a particular movie).

Data analyzer may determine whether the projected data consumption exceeds the data usage threshold (912). If the projected data consumption does not exceed the data usage threshold (912, NO), data analyzer 402 may continue to monitor the user's data consumption (block 904). If the projected data consumption exceeds the data usage threshold (912, YES), data analyzer 402 may send a data usage notification to a designated account, such as the user account and/or the account administrator account (914).

Data analyzer 402 may perform actions to limit data consumption within the data usage threshold (916). Emergency sessions (e.g., E-911) may be identified such that they are always allowed to proceed regardless of any data usage thresholds. According to one example, data analyzer 402 may reduce the user's data consumption. According to another example, data analyzer 402 may expose data usage information to authorized third parties. For example, data analyzer 402 may provide data consumption information to a service provider associated with user sessions for the user account. The service provider may reduce data consumption based on the service that the user receives (e.g., a TV may be data constraint aware). The authorized third party may provide additional data in exchange for the user accepting advertisements, as part of a third party service subscription, etc. According to a further example, data analyzer 402 may allocate data from underutilizing users in the shared data plan.

Systems and/or methods described herein may allow monitoring, notifying, and controlling data usage associated with a user in a shared data plan. The systems and methods may allow an administrator to set thresholds at which network actions are triggered to bring account back into data consumption compliance.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense. For example, while series of blocks have been described with respect to FIG. 9, the order of the blocks may be modified in other implementations. Further, non-dependent blocks may be performed in parallel.

It will be apparent that different aspects of the description provided above may be implemented in many different forms of software, firmware, and hardware in the implementations illustrated in the figures. The actual software code or specialized control hardware used to implement these aspects is not limiting of the invention. Thus, the operation and behavior of these aspects were described without reference to the specific software code—it being understood that software and control hardware can be designed to implement these aspects based on the description herein.

Further, certain portions of the invention may be implemented as a “component” or “system” that performs one or more functions. These components/systems may include hardware, such as a processor, an ASIC, or a FPGA, or a combination of hardware and software.

No element, act, or instruction used in the present application should be construed as critical or essential to the invention unless explicitly described as such. Also, as used herein, the article “a” and “one of” is intended to include one or more items. Further, the phrase “based on” is intended to mean “based, at least in part, on” unless explicitly stated otherwise.

What is claimed is:

1. A computer-implemented method comprising:
identifying a data volume allocation, associated with at least one user account, from a shared data volume allocation;
identifying previous data consumption, corresponding to the data volume allocation, by the at least one user account;
identifying a current data usage rate associated with the at least one user account;
identifying a data usage threshold associated with the at least one user account, wherein the data usage threshold is based on the data volume allocation;
determining a projected data usage based on the current data usage rate and the previous data consumption;
determining whether the projected data usage exceeds the data usage threshold;
if the projected data usage exceeds the data usage threshold, sending a notification indicating that data usage is projected to exceed the data usage threshold to at least one account associated with the shared data plan; and
performing an action to limit data consumption below the data usage threshold.

2. The computer-implemented method of claim 1, wherein performing the action to limit data consumption below the data usage threshold further comprises:
determining whether excess volume allocation is available from the shared data volume allocation; and
allocating additional data volume and increase the data usage threshold.

3. The computer-implemented method of claim 1, wherein performing the action to limit data consumption below the data usage threshold further comprises:
modifying a user network session associated with the user account to reduce the current data usage rate.

4. The computer-implemented method of claim 3, wherein modifying the user network session associated with the user account to reduce the current data usage rate comprises at least one of:
downgrading the user session from a video session to an audio session;
renegotiating an audio codec to a lower quality codec; or
reestablishing the user session to Wi-Fi from a macro-cellular network session.

5. The computer-implemented method of claim 3, wherein modifying the user network session associated with the user account to reduce the current data usage rate further comprises:
minimizing the data usage based on switching the user network session to a lower cost network.

6. The computer-implemented method of claim 1, wherein performing the action to limit data consumption below the data usage threshold further comprises:
exposing data consumption information associated with the at least one user account to an authorized third party; and
receiving an offer to increase the data use threshold from the authorized third party.

7. The computer-implemented method of claim 1, wherein performing the action to limit data consumption below the data usage threshold further comprises:
providing data consumption information to a service provider associated with a user session for the user account; and
having the service provider decrease data consumption associated with the user session.

8. The computer-implemented method of claim 1, wherein performing the action to limit data consumption below the data usage threshold further comprises:
providing data consumption information to a third party service provider;
receiving an offer to provide data associated with a third party data service from the third party service provider, wherein offer is based on the user accepting the third party service;
receiving an acceptance of the third party data service; and
excluding data consumed in association with the third party service from the data usage counted against the data usage threshold.

9. The computer-implemented method of claim 1, wherein identifying the current data usage rate associated with the at least one user account further comprises:
identifying the current data usage rate based on device application information received from a user device associated with the user account.

10. The computer-implemented method of claim 1, wherein the shared data volume allocation is applicable to heterogeneous devices including at least one of a wearable computing device, a smartphone, a tablet, a personal computer, a sensor, or a television.

11. The computer-implemented method of claim 1, wherein sending a notification that the data usage is projected to exceed the data usage threshold further comprises:
sending the notification as at least one of a haptic notification, an audio notification, or a visual notification.

12. The computer-implemented method of claim 1, wherein the data usage threshold comprises one of:
a daily data usage threshold, a weekly data usage threshold, and a monthly data usage threshold.

13. The computer-implemented method of claim 1, wherein the notification is sent to a device associated with an administrative account, and wherein performing the action to limit data consumption below the data usage threshold further comprises:
performing the action based on manual input received via the administrative account.

14. The computer-implemented method of claim 1, wherein sending the notification indicating that the data usage is projected to exceed the data usage threshold further comprises:
sending an offer to allow the user to purchase additional shared data capacity.

15. The computer-implemented method of claim 1, wherein the shared data plan is applicable to one of:
a business group, a family, or a social group.

16. A distribution management device, comprising:
a memory to store a plurality of instructions; and
a processor configured to execute instructions in the memory to:
identify a data volume allocation, associated with at least one user account, from a shared data volume allocation;
identify previous data consumption, corresponding to the data volume allocation, by the at least one user account;
identify a current data usage rate associated with the at least one user account;
identify a data usage threshold associated with the at least one user account, wherein the data usage threshold is based on the data volume allocation;
determine a projected data usage based on the current data usage rate and the previous data consumption;
determine whether the projected data usage exceeds the data usage threshold;
if the projected data usage exceeds the data usage threshold, send a notification indicating that data usage is projected to exceed the data usage threshold to at least one account associated with the shared data plan; and
perform an action to limit data consumption below the data usage threshold.

17. The device of claim 16, wherein, when performing the action to limit data consumption below the data usage threshold, the processor is further configured to:
determine whether excess volume allocation is available from the shared data volume allocation; and
allocate additional data volume and increase the data usage threshold.

18. The device of claim 16, wherein, when performing the action to limit data consumption below the data usage threshold, the processor is further configured to:
modify a user network session associated with the user account to reduce the current data usage rate.

19. The device of claim 16, wherein, when performing the action to limit data consumption below the data usage threshold, the processor is further configured to:
modify a user network session associated with the user account to select a reduced content size

20. A computer-readable medium including instructions to be executed by a processor, the instructions including one or more instructions, when executed by the processor, for causing the processor to:
identify a data volume allocation associated with at least one user account from a shared data volume allocation;
identify previous data consumption corresponding to the data volume allocation by the at least one user account;
identify a current data usage rate associated with the at least one user account;
identify a data usage threshold associated with the at least one user account, wherein the data usage threshold is based on the data volume allocation;
determine a projected data usage based on the current data usage rate and the previous data consumption;
determine whether the projected data usage exceeds the data usage threshold; and
if the projected data usage exceeds the data usage threshold, send a notification indicating that data usage is projected to exceed the data usage threshold to at least one account associated with the shared data plan.
